(19) United States
(12) Patent Application Publication
(10) Pub. No.: US 2025/0332908 A1
(43) Pub. Date: Oct. 30, 2025

(54) VEHICLE FRONT STRUCTURE

(71) Applicant: TOYOTA JIDOSHA KABUSHIKI KAISHA, Toyota-shi (JP)

(72) Inventor: Eiji ISHIKAWA, Toyota-shi (JP)

(73) Assignee: TOYOTA JIDOSHA KABUSHIKI KAISHA, Toyota-shi (JP)

(21) Appl. No.: 19/036,540

(22) Filed: Jan. 24, 2025

(30) Foreign Application Priority Data
Apr. 26, 2024 (JP) 2024-073167

(51) Int. Cl. B60K 11/04; B62D 21/15

(52) U.S. Cl. CPC B60K 11/04; B62D 21/152

(57) ABSTRACT

A vehicle front structure includes a heat exchanger, a front side member extending in the vehicle front-rear direction on both right and left sides in the vehicle width direction in the vehicle front portion, a support portion provided in an intermediate portion in the vehicle front-rear direction of the pair of right and left front side members in the power unit compartment of the vehicle front portion and supporting an intermediate portion in the vehicle up-down direction of the heat exchanger and provided with a fragile portion at a portion on the vehicle rear side, and a fixing portion for fixing the portion on the vehicle front side in the heat exchanger to the vehicle body.

### CROSS-REFERENCE TO RELATED APPLICATION

This application claims priority to Japanese Patent Application No. 2024-073167 filed on Apr. 26, 2024, incorporated herein by reference in its entirety.

### BACKGROUND

### 1. Technical Field

The present disclosure relates to vehicle front structures.

### 2. Description of Related Art

Japanese Unexamined Patent Application Publication No. 2002-362171 (JP 2002-362171 A) discloses a vehicle in which a radiator is mounted in a tilted manner with its upper side in a vehicle up-down direction located closer to the rear in a vehicle front-rear direction of the vehicle.

### SUMMARY

In recent years, it has been considered to mount a radiator in a tilted manner in order to cause wind to hit the entire radiator. In case of a frontal collision, the impact is absorbed by axial compression of front side members. In the case where a radiator is mounted in a tilted manner, however, the lower end of the radiator protrudes forward. Therefore, there is a possibility that an object involved in the frontal collision may contact and damage the radiator during impact absorption. Accordingly, there is room for improvement in radiator mounting structure.

The present disclosure was made in view of such circumstances, and an object of the present disclosure is to provide a vehicle front structure that can avoid damage to a heat exchanger.

A vehicle front structure of the present disclosure of claim 1 includes: a heat exchanger;
front side members extending in a vehicle front-rear direction respectively at both right and left sides in a vehicle width direction of a front part of a vehicle;
a support portion provided on each of intermediate portions in the vehicle front-rear direction of a pair of the right and left front side members in a power unit compartment in the front part of the vehicle, the support portion supporting an intermediate portion in a vehicle up-down direction of the heat exchanger, and a fragile portion being provided in a rear portion in the vehicle front-rear direction of the support portion; and
a fixing portion that fixes a front portion in the vehicle front-rear direction of the heat exchanger to a vehicle body.

In the vehicle front structure of the present disclosure of claim 1, the support portion that supports the intermediate portion in the vehicle up-down direction of the heat exchanger and that includes the fragile portion in its rear portion in the vehicle front-rear direction is provided on each of the intermediate portions in the vehicle front-rear direction of the front side members. The fixing portion is also provided that fixes the front portion in the vehicle front-rear direction of the heat exchanger to the vehicle body. Therefore, when a frontal collision occurs and an object involved in the frontal collision contacts the heat exchanger during impact absorption by axial compression of the front side members, the front portion in the vehicle front-rear direction of the heat exchanger is released from the fixing portion, and the fragile portion provided in the rear portion in the vehicle front-rear direction of the support portion is broken, so that the heat exchanger is disengaged from the support portion toward the rear of the vehicle. This allows a load that is applied to the heat exchanger to escape, so that damage to the heat exchanger can be avoided.

According to the vehicle front structure of the present disclosure of claim 2, in the configuration of claim 1, the fragile portion may be composed of a groove.

In the vehicle front structure of the present disclosure of claim 2, the fragile portion is composed of the groove. Therefore, required strength can be easily implemented by changing the depth, width, etc. of the groove according to the vehicle model etc.

According to the vehicle front structure of the present disclosure of claim 3, in the configuration of claim 1 or 2, the heat exchanger may include a protruding portion in the intermediate portion of the heat exchanger, the protruding portion may protrude outward in the vehicle width direction, and
the support portion may support the protruding portion.

In the vehicle front structure of the present disclosure of claim 3, the support portion supports the protruding portion provided in the intermediate portion in the vehicle up-down direction of the heat exchanger and protruding outward in the vehicle width direction. Therefore, when the fragile portion provided in the rear portion in the vehicle front-rear direction of the support portion is broken, the protruding portion can be disengaged from this broken portion.

According to the vehicle front structure of the present disclosure of claim 4, in the configuration of claim 3, the support portion may include, on an outer side surface in the vehicle width direction of the support portion, an elastic mount portion through which the protruding portion is inserted.

In the vehicle front structure of the present disclosure of claim 4, the support portion includes, on its outer side surface in the vehicle width direction, the elastic mount portion through which the protruding portion of the heat exchanger is inserted. The mount portion can reduce wobbling of the protruding portion.

According to the vehicle front structure of the present disclosure of claim 5, in the configuration of any one of claims 1 to 4, the vehicle front structure may further include a cross member disposed at a front side in the vehicle front-rear direction of the heat exchanger and extending in the vehicle width direction, and
the fixing portion may fix the front portion in the vehicle front-rear direction of the heat exchanger to the cross member.

In the vehicle front structure of the present disclosure of claim 5, the front portion in the vehicle front-rear direction of the heat exchanger is fixed to the cross member by the fixing portion. In other words, the front portion in the vehicle front-rear direction of the heat exchanger, namely a portion of the heat exchanger to which a load is applied earlier in case of a frontal collision, is fixed to the cross member. Therefore, the heat exchanger can be released more quickly from the fixing portion.

As described above, the vehicle front structure according to the present disclosure can avoid damage to the heat exchanger.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a left side view schematically illustrating an example of a vehicle front structure according to a first embodiment of the present disclosure;

FIG. 2 is a front view schematically illustrating an example of the vehicle front structure of FIG. 1;

FIG. 3 is a perspective view schematically showing a support portion;

FIG. 4 is a left side view schematically showing the vicinity of the fixing portion;

FIG. 5 is a left side view schematically illustrating a modification of the fixing method of the shaft portion;

FIG. 6 is a partially enlarged top view of the cross member;

FIG. 7 is a left side view corresponding to FIG. 4 schematically illustrating a variation; and

FIG. 8 is a left side view schematically illustrating an example of a vehicle front structure according to a second embodiment of the present disclosure.

### DETAILED DESCRIPTION OF EMBODIMENTS

Hereinafter, a vehicle front structure according to an embodiment of the present disclosure will be described with reference to the accompanying drawings. In the present specification and the drawings, constituent elements having substantially the same functional configuration are denoted by the same reference numerals, and redundant description thereof will be omitted. Further, an arrow FR appropriately shown in the drawings indicates a front side in the vehicle front-rear direction, and an arrow UP indicates an upper side in the vehicle up-down direction. The arrow IN indicates the inner side in the vehicle width direction. Hereinafter, in the case of simply describing the front-rear direction, the up-down direction, and the left-right direction, the front-rear direction of the vehicle front-rear direction, the up-down direction of the vehicle up-down direction, and the left-right direction of the vehicle (the vehicle width direction) are shown unless otherwise specified.

### Configuration of Vehicle Front Structure

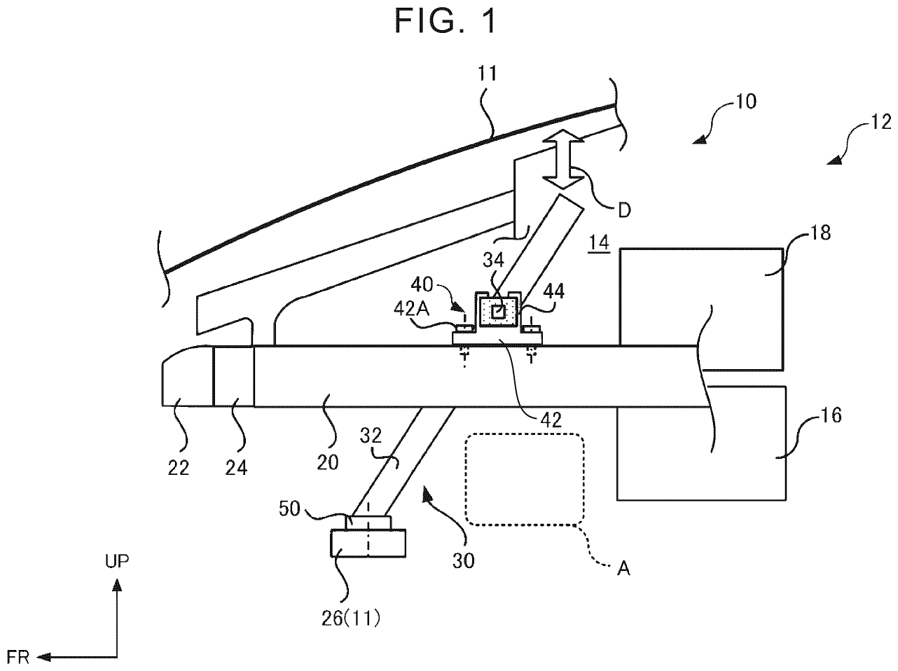

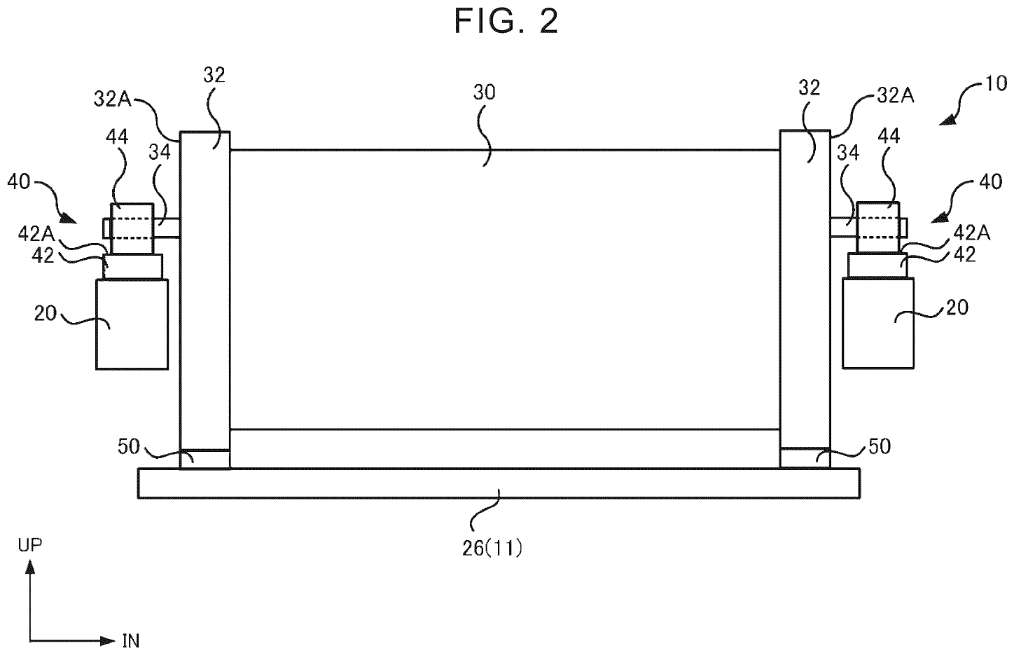

First, a configuration of the vehicle front structure 10 will be described as an example of a vehicle front structure according to an embodiment of the present disclosure. FIGS. 1 and 2 schematically show a vehicle front structure 10 of a vehicle 12. In the present embodiment, the vehicle 12 is, for example, a battery-type battery electric vehicle including a battery and a motor as a drive source.

As shown in FIG. 1, a power unit compartment 14 is disposed rearward of a bumper (not shown) in the vehicle front-rear direction at the front of the vehicle 12. A power unit 16 is housed inside the power unit compartment 14. In the present embodiment, since the vehicle 12 is a battery electric vehicle, the power unit 16 is a drive unit and includes an electric motor that generates a driving force for rotating drive wheels (not shown) of the vehicle. A battery stack 18 as a battery is disposed directly above the power unit 16. The battery stack 18 is formed by stacking a plurality of battery cells (not shown) in a predetermined direction. Each battery cell stores electric power for rotating the electric motor of the power unit 16.

As illustrated in FIGS. 1 and 2, the vehicle front structure 10 includes a pair of right and left front side members 20 that is front skeletal members of the vehicle body 11 of the vehicle 12 and are disposed at both sides in the vehicle width direction of the front part of the vehicle. The front side member 20 is a vehicle body skeleton member, and extends in the vehicle front-rear direction, and is formed in, for example, a closed sectional structure. The front end portion of the front side member 20 is connected to a front bumper reinforcement 22 (hereinafter referred to as “bumper RF22”) disposed along the vehicle width direction. In the present embodiment, the front side member 20 includes a crash box 24 as an energy absorbing member at a front end portion connected to the bumper RF22. The front side member 20 is fixed coaxially with respect to the crash box 24 so that a collision load from the front of the vehicle body 11 is reduced. Although the crash box 24 is described as a separate component from the bumper RF22 in the present embodiment, the crash box may be integrated with the crash box.

Inside the power unit compartment 14, a radiator 30 as a heat exchanger is disposed at a position closer to the front of the vehicle than the power unit 16. As shown in FIG. 1, the radiator 30 of the present embodiment is disposed so as to be inclined so that the vehicle upper portion is positioned on the vehicle rear side. Although not shown, a cylindrical fan shroud, an electric fan, and the like for guiding the air introduced from the radiator 30 toward the rear of the vehicle are disposed rearward of the radiator 30 in the vehicle front-rear direction.

The radiator 30 is, for example, a structure that is formed in a substantially rectangular frame shape when viewed in the vehicle front-rear direction and is flat in the vehicle front-rear direction, and is provided with a refrigerant pipe (not shown) that meanders to reciprocate a plurality of times in the vehicle width direction as an example. A plurality of fins (not shown) is attached to the refrigerant pipe, and the atmosphere introduced into the inside of the power unit compartment 14 passes between the fins through a front grille (not shown) while the vehicle 12 is traveling to cool the refrigerant inside the refrigerant pipe. The refrigerant pipe circulates in the flow path inside the power unit 16 and the battery stack 18, and the refrigerant pumped by a pump (not shown) circulates inside the power unit 16 and the battery stack 18 through the refrigerant pipe to exchange heat. Accordingly, the power unit 16 and the battery stack 18 are cooled.

Although not shown in the drawings, a tank in which a refrigerant is stored is attached to the radiator 30 at both ends in the vehicle width direction as an example. A pipe connected to a flow path inside the power unit 16 and the battery stack 18 is inserted into the pair of right and left tanks.

As shown in FIG. 2, the radiator 30 is supported by the vehicle body 11 by radiator supports 32 fixed to both end portions in the vehicle width direction. The radiator support 32 is a hollow member having a horizontal cross section formed in a substantially rectangular shape, and is constituted by a side member elongated in the vehicle up-down direction. The radiator support 32 may further include an upper support member (not shown) and a lower support member (not shown) each extending in the vehicle width direction in the up-down direction of the radiator 30.

In the present embodiment, as an example, an end portion of each radiator support 32, which is a side member, on the outer side in the vehicle width direction is supported by a front side member 20 as a skeleton frame of the vehicle body 11 of the vehicle 12. Specifically, the radiator supports 32 include, on the outer surface 32A on the outer side in the vehicle width direction, a quadrangular prism-shaped shaft portion 34 protruding outward in the vehicle width direction. The shaft portion 34 corresponds to a protruding portion of the present disclosure. As shown in FIG. 2, the shaft portion 34 is provided at an intermediate portion in the vehicle up-down direction, and is provided above the center in the vehicle up-down direction as an example in the present embodiment. Here, the intermediate portion in the vehicle up-down direction is intended to be a range excluding the upper end and the lower end in the vehicle up-down direction. In the present embodiment, as an example, the shaft portion 34 is made of resin.

The shaft portion 34 may be inserted into a shaft hole (not shown) provided on the outer surface 32A of the radiator support 32 and fixed by a screw or the like, for example, or a flange may be provided at one end of the shaft portion 34, and the flange may be attached to the outer surface 32A by a screw or the like. As the fixing method, a known technique can be used.

As shown in FIG. 1, the shaft portion 34 is supported in the vehicle width direction as an axial direction by a support portion 40 provided in an intermediate portion of the pair of right and left front side members 20 in the vehicle front-rear direction in the power unit compartment 14.

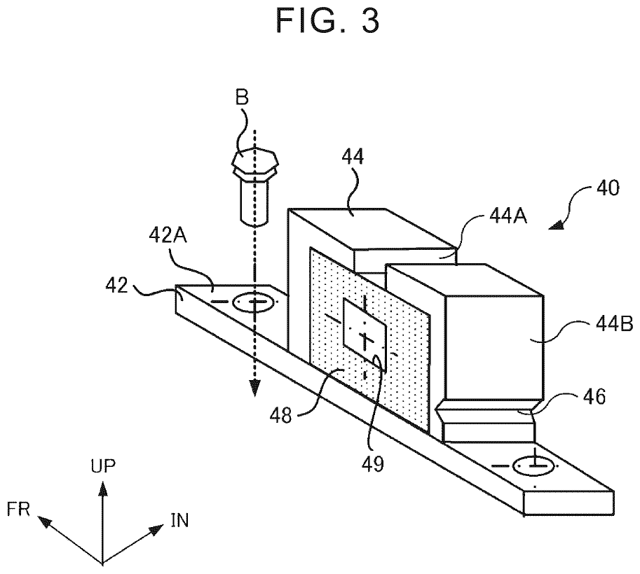

As shown in FIG. 3, the support portion 40 includes a support base 42 and a bearing portion 44. The support base 42 and the bearing portion 44 may be integrally formed or may be separately formed. The support base 42 is formed in a substantially rectangular shape when viewed from the up-down direction, and is fastened to the upper surface of the front side member 20 by, for example, a bolt B at two positions having a gap in the vehicle front-rear direction as an example.

The bearing portion 44 is in the shape of a substantially rectangular parallelepiped, and includes, in its central portion in the vehicle front-rear direction, a recess 44A that is open on its upper side. In addition, the bearing portion 44 has a groove 46 extending along the entire length in the vehicle width direction in a lower portion of the rear surface 44B. As an example, the groove 46 is formed so as to have a sharp tip. The groove 46 is an example of a fragile portion of the present disclosure.

In addition, the bearing portion 44 includes a mount portion 48 formed of a rectangular rubber member on an outer side surface in the vehicle width direction. The mount portion 48 includes a rectangular insertion hole 49 through which the shaft portion 34 provided in the radiator support 32 is inserted. The bottom surface of the recess 44A described above is formed so as to be positioned above the upper surface of the insertion hole 49, and a rectangular shaft hole (not shown) through which the shaft portion 34 is inserted is provided in a lower portion of the recess 44A. Note that, in the present embodiment, the mount portion 48 is formed with a strength such that it breaks when a load is applied to the shaft portion 34 toward the rear side.

The bearing portion 44 is disposed on the upper surface 42A of the support base 42 such that the axial direction of the insertion hole 49 is the vehicle width direction. The bearing portion 44 supports the shaft portion 34 with the vehicle width direction as an axis. That is, the support portion 40 supports the shaft portion 34 from the vehicle width direction side.

As shown in FIGS. 1 and 2, the vehicle front structure 10 includes a cross member 26 disposed on the front side of the radiator 30 and extending in the vehicle width direction. In the present embodiment, the cross member 26 is, for example, a lower absorber. The lower absorber has a function of absorbing and reducing the impact energy when the lower absorber collides with a pedestrian in front, and is formed of a foamed resin material, a plastic resin material, or the like. As an example, a front portion of the cross member 26 in the vehicle front-rear direction is fixed to a bottom portion of a front bumper cover (not shown) by fixing means such as bolt fastening.

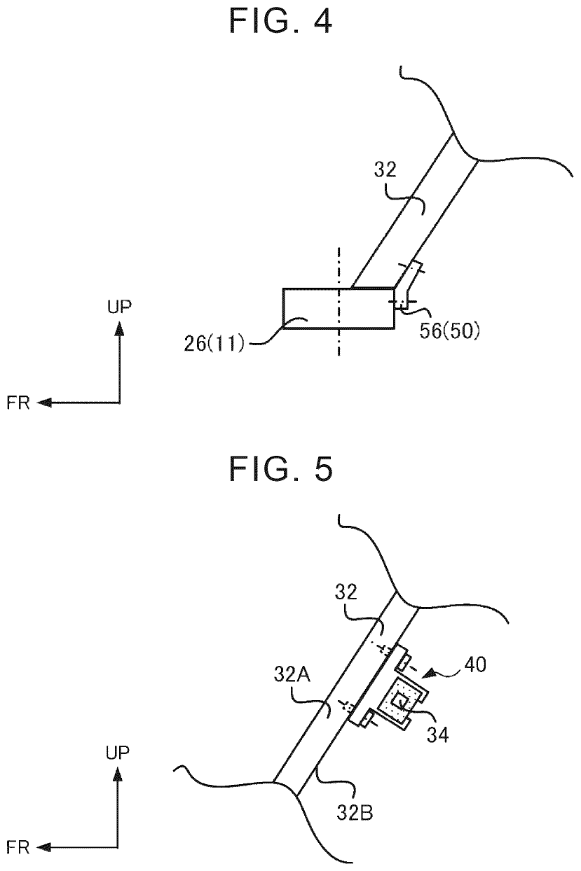

In the present embodiment, as an example, a lower end portion of the radiator 30, namely a front portion in the vehicle front-rear direction of the radiator 30, is fixed to the cross member 26 as the vehicle body 11 by the fixing portion 50. FIG. 4 is a left side view schematically illustrating the vicinity of the fixing portion 50. Specifically, for example, as shown in FIG. 4, the fixing portion 50 includes a bracket 56. As an example, the bracket 56 is formed of a plate member having a bent portion whose vehicle front side is convex at substantially the center in the vehicle up-down direction. By fixing the boundary portion between the cross member 26 and the radiator support 32 from the rear side of the vehicle by screws or the like by the bracket 56, the front portion in the vehicle front-rear direction of the radiator 30 is fixed to the cross member 26 via the radiator support 32. Note that, as shown in FIG. 4, since the front side in the vehicle front-rear direction of the cross member 26 is located closer to the front of the vehicle than the radiator support 32, a load is applied to the cross member 26 before the radiator support 32 in case of a frontal collision. When a load from the front side of the vehicle is applied to the cross member 26, the bracket 56 is pressed toward the rear of the vehicle together with the cross member 26. In the present embodiment, the bracket 56 and the radiator support 32 are fixed to the extent that the bracket 56 is disengaged when being pressed toward the rear of the vehicle.

### Functions and Effects of First Embodiment

Next, functions and effects of the first embodiment will be described.

In the vehicle front structure 10 of the first embodiment, a support portion 40 that rotatably supports an intermediate portion in the vehicle up-down direction of the radiator 30 with the vehicle width direction as an axial direction is provided in an intermediate portion in the vehicle front-rear direction of the front side member 20. Further, a fixing portion 50 that fixes a front portion in the vehicle front-rear direction of the radiator 30 to the vehicle body 11 is provided. Therefore, when a frontal collision occurs and an object involved in the frontal collision contacts the radiator 30 during impact absorption by axial compression of the front side member 20, the radiator 30 is released from the fixing portion 50 provided at the front side in the vehicle front-rear direction of the radiator 30. Thus, since the radiator 30 moves toward the vehicle direction side, a load is applied to the bearing portion 44 via the shaft portion 34, the bearing portion 44 is broken in the groove 46 as a fragile portion provided in the rear portion in the vehicle front-rear direction, and the mount portion 48 is also broken. Then, the radiator 30 is disengaged from the broken bearing portion 44 toward the rear of the vehicle. As a result, the load applied to the radiator 30 can be released, so that damage to the radiator 30 can be avoided.

The vehicle front structure 10 of the first embodiment is applied to a vehicle 12 including a battery stack 18 as a battery and a power unit 16 incorporating an electric motor as a drive source. Since the vehicle 12 is a battery-powered battery electric vehicle, the position of the front grille is lowered. Therefore, the radiator 30 is mounted obliquely from the viewpoint of applying wind to the entire radiator 30. Normally, in a forward collision, the front side member 20 is axially compressed to absorb an impact. However, when the radiator 30 is mounted obliquely, the lower end of the radiator 30 protrudes forward, and thus there is a possibility that the colliding object comes into contact with the radiator 30 and is damaged in the middle of shock absorption. In the vehicle front structure 10 of the first embodiment, the colliding object comes into contact with the radiator 30 during the shock absorption in the axial compression of the front side member 20 in the case of a forward collision. At this time, in the vehicle front structure 10 of the first embodiment, the radiator 30 is released from the fixing portion 50 provided at the front side in the vehicle front-rear direction of the radiator 30, and moves toward the rear of the vehicle and breaks the bearing portion 44 and the mount portion 48. Then, the radiator 30 is disengaged from the broken bearing portion 44 toward the rear of the vehicle. As a result, the load applied to the radiator 30 can be released, and thus a higher effect can be obtained in a vehicle including a battery and a motor as a drive source.

In the vehicle front structure 10 of the first embodiment, the radiator 30 is inclined so that the upper side in the vehicle up-down direction is positioned on the rear side in the vehicle front-rear direction. Therefore, as shown in FIG. 1, an empty space A indicated by a dotted rectangle can be formed in a lower portion of the radiator 30 in the vehicle up-down direction rearward and rearward in the vehicle front-rear direction. Therefore, this free space A can be used as a space for the radiator 30 to move. Further, by disposing the radiator 30 in an inclined manner, the height of the radiator 30 in the up-down direction can be made lower than in the case where the radiator 30 is vertically disposed. As a result, as indicated by arrow D in FIG. 1, an empty space for pedestrian protection can be easily secured between the vehicle body 11 and the radiator 30.

Further, in the vehicle front structure 10 of the first embodiment, since the fragile portion is constituted by the groove 46, by changing the depth and groove width of the groove 46 and the like, it is possible to easily realize the necessary strength according to the vehicle type and the like.

Further, in the vehicle front structure 10 of the first embodiment, the support portion 40 supports the shaft portion 34 as a protruding portion protruding outward in the vehicle width direction at an intermediate portion in the vehicle up-down direction of the radiator 30. Therefore, when the groove 46 as the fragile portion provided in the rear portion in the vehicle front-rear direction of the shaft portion 34 is broken, the shaft portion 34 can be disengaged from the broken portion.

Further, in the vehicle front structure 10 of the first embodiment, since the support portion 40 has elasticity on the side surface on the outer side in the vehicle width direction and includes the mount portion 48 through which the shaft portion 34 of the radiator 30 is inserted, it is possible to suppress the fluctuation of the shaft portion 34 by the mount portion 48.

In the vehicle front structure 10 of the first embodiment, a front portion in the vehicle front-rear direction of the radiator 30 is fixed to the cross member 26 by the bracket 56 of the fixing portion 50. Therefore, the front portion in the vehicle front-rear direction of the radiator 30, namely a portion of the radiator 30 to which a load is applied earlier in case of a frontal collision, is fixed to the cross member 26. Therefore, the radiator 30 is more quickly released from the bracket 56. In the first embodiment, as shown in FIG. 3, since the front side in the vehicle front-rear direction of the cross member 26 is located closer to the front of the vehicle than the radiator support 32, a load is applied to the cross member 26 before the radiator support 32 in case of a frontal collision. When the load from the front side of the vehicle is applied to the cross member 26, the bracket 56 is pressed toward the rear of the vehicle together with the cross member 26. The bracket 56 and the radiator support 32 are fixed to such an extent that the bracket 56 is disengaged when pushed toward the rear of the vehicle. Therefore, the bracket 56 is disengaged when a load from the front side of the vehicle is applied to the cross member 26.

Further, in the vehicle front structure 10 of the first embodiment, since the support portion 40 supports the shaft portion 34 of the radiator 30 from the vehicle width direction side, it is possible to further reduce damage to the support portion 40 that is caused when hit by an object involved in a collision, as compared with the case where the support portion is supported from the front side of the vehicle. Accordingly, it is possible to further enhance the certainty of avoiding the damage of the radiator 30.

In the vehicle front structure 10 of the first embodiment, since the shaft portion 34 is made of resin, the weight of the vehicle 12 can be reduced.

### Modification 1

In the first embodiment, the support portion 40 supports the shaft portion 34 of the radiator 30 from the vehicle width direction side, but the present disclosure is not limited to this. In Modification 1, as shown in FIG. 5, the shaft portion 34 is fixed to the rear surface 32B on the rear side of the vehicle, not to the outer surface 32A of the radiator support 32. Specifically, as an example, the shaft portion 34 disposed such that one end thereof protrudes horizontally in the vehicle width direction from the radiator support 32 in the rear surface 32B is fixed to the rear surface 32B of the radiator support 32 by the support portion 40. The support portion 40 is fixed to the radiator support 32 by, for example, screwing. The shaft portion 34 protruding from the radiator support 32 is supported by the support portion 40 in the same manner as in the first embodiment.

In Modification 1, since the support portion 40 supports the shaft portion 34 of the radiator 30 from the rear side in the vehicle front-rear direction, it is possible to further reduce damage to the support portion 40 that is caused when hit by an object involved in a collision, as compared with the case where the support portion is supported from the front side of the vehicle. Accordingly, it is possible to further enhance the certainty of avoiding the damage of the radiator 30.

### Modification 2

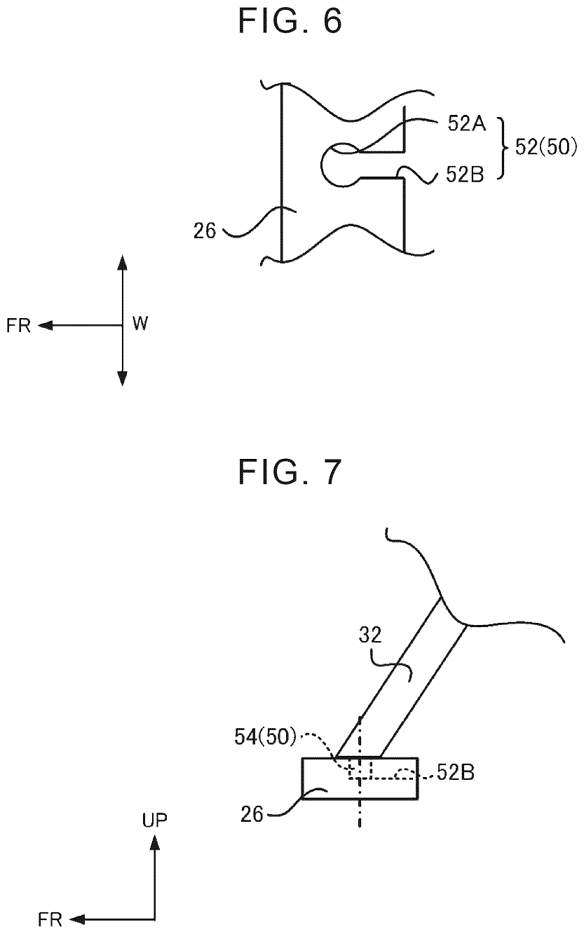

In the above embodiment, the radiator 30 is fixed to the cross member 26 via the bracket 56 as the fixing portion 50, but the present disclosure is not limited thereto. In Modification 2, as shown in FIG. 6, the notch portion 52 is provided in the cross member 26. The notch portion 52 includes a hole 52A formed in a substantially circular shape, and a cut portion 52B connected to the hole 52A and cut out to the rear end of the cross-member 26. The hole 52A is formed to be slightly larger than the pin portion 54 described later. The cut portion 52B extends in the vehicle front-rear direction, and the width in the vehicle width direction is formed to be slightly smaller than the pin portion 54 described later. As shown in FIG. 7, the radiator support 32 includes a pin portion 54 formed of a cylinder extending substantially perpendicularly downward from a lower end surface in the vehicle up-down direction. In Modification 2, the notch portion 52 and the pin portion 54 constitute the fixing portion 50.

In Modification 2, when the collision object contacts the radiator support 32 at the time of the forward collision, the pin portion 54 moves while pressing the inside of the cut portion 52B in the vehicle width direction, and falls off from the notch portion 52, that is, the cross member 26. Thus, the radiator 30 is released from the fixing portion 50 and moves toward the rear of the vehicle. As a result, as in the first embodiment, the load applied to the radiator 30 can be released even in the second modification, so that damage to the radiator 30 can be avoided.

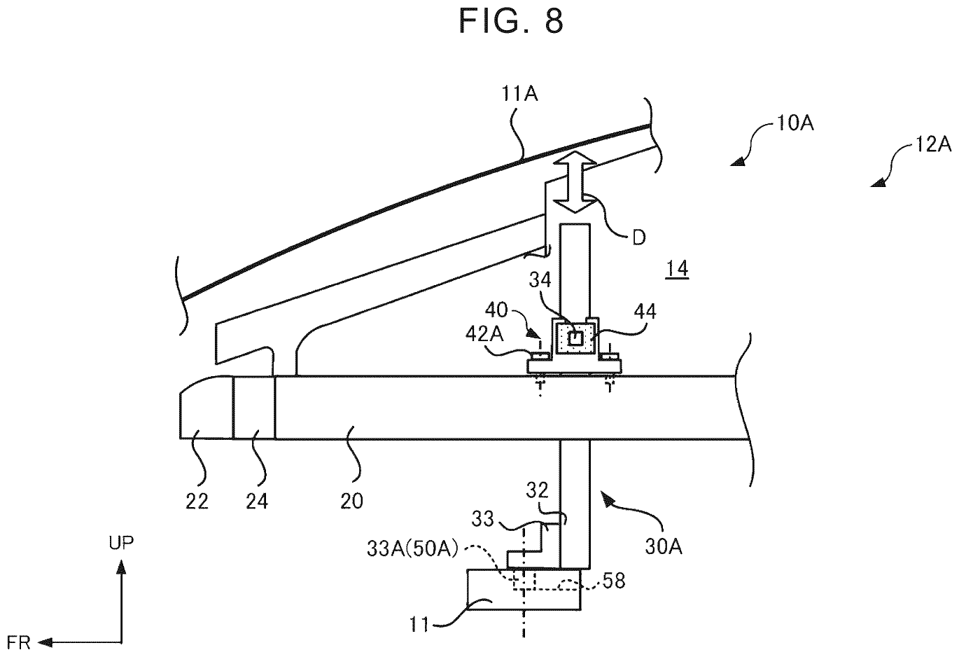

Next, a vehicle front structure 10A according to a second embodiment of the present disclosure will be described. As shown in FIG. 8, in the vehicle front structure 10A of the second embodiment, the arrangement of the radiator 30A is different from that of the radiator of the first embodiment. The radiator 30 of the first embodiment is disposed in a tilted manner, whereas the radiator 30A of the second embodiment is disposed so as to stand in the vehicle up-down direction.

Further, the radiator 30A includes, in its lower end in the vehicle up-down direction, brackets 33 arranged so as to protrude toward the front of the vehicle. The bracket 33 is formed substantially in a reversed L shape in a side view, and one piece thereof is fixed to the radiator support 32 of the radiator 30, and the other piece thereof is fixed to the vehicle body 11. The bracket 33 and the radiator support 32 are fastened by screws or the like as an example.

The lower surface of the other piece of the bracket 33 is provided with a substantially cylindrical pin 33A protruding downward. Further, the vehicle body 11 is provided with a notch portion 58. Note that the notch portion 58 has the same configuration as the notch portion 52 shown in FIG. 5. When the pin 33A is fitted into the notch portion 58, the radiator support 32 is fixed to the vehicle body 11 via the bracket 33. In the present embodiment, the notch portion 58 and the pin 33A form a fixing portion 50A.

### Functions and Effects of Second Embodiment

Next, functions and effects of the second embodiment will be described.

In the vehicle front structure 10A of the second embodiment, the radiator 30A is disposed so as to stand in the vehicle up-down direction. Therefore, damage to the radiator 30A can be avoided even in vehicles other than battery electric vehicles.

Further, in the vehicle front structure 10A of the second embodiment, the fixing portion 50A fixes the radiator 30A to the vehicle body 11 via the bracket 33 disposed so as to protrude toward the front side in the vehicle front-rear direction. Therefore, the collision load can be applied to the bracket 33 before the radiator 30A in the forward collision. The radiator 30A can thus be more quickly released from the fixing portion 50A. Also, in the vehicle front structure 10A of the second embodiment, it is possible to obtain the same effects as those of the first embodiment described above except for the effects relating to the fact that the radiator 30 is disposed in a tilted manner.

### Remark

In the above embodiment, the radiator 30 is of a lateral flow type in which the refrigerant flows horizontally, but the present disclosure is not limited thereto. For example, the radiator 30 may have an upper tank and a lower tank instead of a pair of right and left tanks, and may be a vertical flow system in which the refrigerant flows from the upper to the lower. A known device can be used as the radiator 30.

In the above embodiment, the cross member 26 is a lower absorber, but the present disclosure is not limited thereto, and any member may be used as long as it is a member that is pushed when a collision load from the front is applied. Further, the fixing portion 50 may be fixed to the vehicle body 11 other than the cross member 26 by using, for example, a bracket or the like without fixing the radiator 30 to the cross member 26. In this case, the vehicle body 11 used for fixing is a member that is pushed when a collision load from the front is applied.

Further, in the above embodiment, the radiator has been described as an example of the heat exchanger, but the heat exchanger of the present disclosure is not limited to the radiator. The heat exchanger may be, for example, a condenser, a heat exchanger for air conditioning of a vehicle, or the like.

In the above embodiment, the groove 46 is described as an example of the fragile portion. However, the present disclosure is not limited to this. For example, the fragile portion may be formed in the bearing portion 44 such that the thickness in the vehicle front-rear direction of the entire portion of the bearing portion 44 that is located closer to the rear of the vehicle than the recess 44A is smaller than the thickness of the entire portion of the bearing portion 44 that is located closer to the front of the vehicle than the recess 44A. Further, for example, the fragile portion may be formed by providing a plurality of notches toward the front from the rear surface 44B.

Further, in the first embodiment described above, the bracket 56 is fixed to the boundary portion between the cross member 26 and the radiator support 32 by screws or the like from the rear side of the vehicle, but the present disclosure is not limited thereto. For example, it may be fixed from the front side of the vehicle. In this case, the bracket 56 is formed with such a strength that the bracket 56 is broken when a load is applied from the front side of the vehicle.

Further, the configuration of the present disclosure is not limited to the above embodiment, and the configuration can be changed as appropriate as long as the problem can be solved.

What is claimed is:

1. A vehicle front structure comprising:
a heat exchanger;
front side members extending in a vehicle front-rear direction respectively at both right and left sides in a vehicle width direction of a front part of a vehicle;
a support portion provided on each of intermediate portions in the vehicle front-rear direction of a pair of the right and left front side members in a power unit compartment in the front part of the vehicle, the support portion supporting an intermediate portion in a vehicle up-down direction of the heat exchanger, and a fragile portion being provided in a rear portion in the vehicle front-rear direction of the support portion; and
a fixing portion that fixes a front portion in the vehicle front-rear direction of the heat exchanger to a vehicle body.

2. The vehicle front structure according to claim 1, wherein the fragile portion is composed of a groove.

3. The vehicle front structure according to claim 1, wherein:
the heat exchanger includes a protruding portion in the intermediate portion of the heat exchanger, the protruding portion protruding outward in the vehicle width direction; and
the support portion supports the protruding portion.

4. The vehicle front structure according to claim 3, wherein the support portion includes, on an outer side surface in the vehicle width direction of the support portion, an elastic mount portion through which the protruding portion is inserted.

5. The vehicle front structure according to claim 1, further comprising a cross member disposed at a front side in the vehicle front-rear direction of the heat exchanger and extending in the vehicle width direction, wherein the fixing portion fixes the front portion in the vehicle front-rear direction of the heat exchanger to the cross member.
